(19) United States
(12) Patent Application Publication
(10) Pub. No.: US 2023/0192218 A1
(43) Pub. Date: Jun. 22, 2023

(54) WIRELESS CONTROL SYSTEM OF E-BIKE AND E-BIKE HAVING SAME

(71) Applicant: FOXCONN INTERCONNECT TECHNOLOGY LIMITED, Grand Cayman (KY)

(72) Inventor: CHIA-YEN LEE, New Taipei (TW)

(21) Appl. No.: 17/709,839

(22) Filed: Mar. 31, 2022

(30) Foreign Application Priority Data
Dec. 22, 2021 (CN) 202111577341.1

(51) Int. Cl. B62J 45/20; B62J 50/22; B62K 23/02; B62M 25/08

(52) U.S. Cl. CPC B62J 45/20; B62J 50/22; B62K 23/02; B62M 25/08; G06F 3/04883

(57) ABSTRACT

A wireless control system of e-bike includes a control module, a display, a power control module, and an execution module. The control module detects operation signals from a rider of the e-bike. The display transmits the operation signals and displays information of the e-bike, and information to and concerning the rider, and the operation signals. The power control module receives the operation signals and adjusts an auxiliary power according to the operation signals. The execution module adjusts a speed of the e-bike and a status of lights of the e-bike. An e-bike having the wireless control system is also provided.

### CROSS-REFERENCE TO RELATED APPLICATIONS

This application claims priority to Chinese Patent Application No. 202111577341.1 filed on Dec. 22, 2021, in China National Intellectual Property Administration, the contents of which are incorporated by reference herein.

### FIELD

The subject matter herein generally relates to electric bicycle (e-bike) technology, and particularly to a wireless control system of e-bike and an e-bike having the system.

### BACKGROUND

E-bikes are becoming very popular, convenient, and environmental friendly. However, the connection cables between a controller and a display of e-bikes may not be easily or neatly or conveniently fitted on a handlebar of the e-bike. There are physical buttons on the e-bikes which are difficult to access when riding the e-bikes. Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block view of at least one embodiment of a wireless control system of e-bike.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

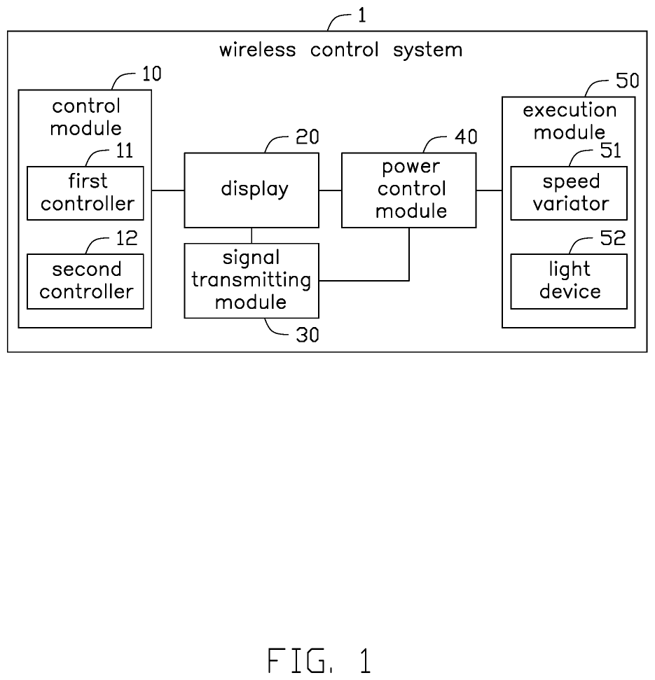

FIG. 1 illustrates at least one embodiment of a wireless control system 1 of e-bike combining touch control technology, wireless communication, and bicycle control system, providing more convenience, better appearance, additional riding functions, and better safety.

The wireless control system 1 includes a control module 10, a display 20, a signal transmitting module 30, a power control module 40, and an execution module 50.

The control module 10 is configured to control the e-bike. The control module 10 includes a first controller 11 and a second controller 12 arranged on handlebars of the e-bike. The handlebars extend to either side of a rider of the e-bike, that is, the first controller 11 and the second controller 12 may be at ends of handlebars, at each side of the rider. The first controller 11 and the second controller 12 may be wireless touch controllers, which may transmit wireless signals. Each of the first controller 11 and the second controller 12 may include a touch interface, which the rider may operate with some control gestures on the touch interface to control the e-bike. The first controller 11 and the second controller 12 may generate operation signals according to the control gestures of the rider. The operation signals may include, but are not limited to, power control signals, speed control signals, and lighting control signals. In at least one embodiment, the control module 10 may be made of waterproof materials and designed with fewer physical buttons, which may save a manufacturing cost and improve a convenience.

In at least one embodiment, the first controller 11 and the second controller 12 may include battery for providing power. The first controller 11 and the second controller 12 may have similar structures, but can control different functions of the e-bike. For instance, the first controller 11 is configured to control a power level and generation of an auxiliary power of the e-bike, the second controller 12 is configured to control a gear of the e-bike.

In at least one embodiment, the first controller 11 and the second controller 12 may trigger different functions according to different touch gestures of the rider. For instance, when the first controller 11 detects an upglide gesture, the e-bike may increase the auxiliary power, when the second controller 12 detects an upglide gesture, the e-bike may upshift in gear. When the first controller 11 detects a downglide gesture, the e-bike may decrease the auxiliary power, when the second controller 12 detects a downglide gesture, the e-bike may downshift in gears. When the second controller 12 detects an upglide and hold down gesture, the e-bike may step upwards through the gears, when the second controller 12 detects a downglide and hold down gesture, the e-bike may step downwards through the gears.

In at least one embodiment, the first controller 11 and the second controller 12 may customize touch gestures for different functions of the e-bike. Thus, when the rider is riding the e-bike, the rider may form habitual gestures of his own for different functions, which improves a riding safety and make it easier to control the e-bike.

The display 20 may be arranged in a middle of the handlebar. The display 20 may be a wireless display that can transmit and receive wireless signals or signals by cable connection. The display 20 may be configured to receive operation signals transmitted by the first controller 11 and the second controller 12 in wireless communication. The display 20 can also be connected to the signal transmitting module 30 and the power control module 40 by cables, so as to transmit signals to the signal transmitting module 30 and obtain power from the power control module 40.

The display 20 may display a plurality of pages, such as date, time, battery status, status of the power control module 40, riding information, and physiological information of the rider, etc. The rider may browse and switch pages in the display 20 for information of the e-bike and the rider.

In at least one embodiment, the display 20 may switch the pages through the touch gesture detected by the first controller 11. For instance, when the first controller 11 detects a click, the display 20 switches to a new page. When the first controller 11 detects a hold down gesture, the display 20 displays a home page. The display 20 obtains the operation signals from the control module 10 wirelessly so as to switch pages, therefore, the e-bike uses fewer cables that decrease the weight and improve an appearance.

The signal transmitting module 30 may be a wireless signal transceiver, which can transmit and receive wireless signals and wired signals through signal cables. The signal transmitting module 30 is configured to receive the operation signals transmitted by the display 20 and forward same to the power control module 40. In at least one embodiment, the signal transmitting module 30 and the power control module 40 may be connected by cables, so the signal transmitting module 30 may transmit the operation signals and obtain power through the cables.

The power control module 40 may be connected to the display 20 and the signal transmitting module 30 by cables and configured to provide power to the display 20 and the signal transmitting module 30, and receive the operation signals from the signal transmitting module 30. The power control module 40 is further configured to generate, increase, or decrease the auxiliary power according to the operation signals, so as to cause the execution module 50 to execute commands.

The execution module 50 may be connected to the power control module 40 by cables and configured to receive the operation signals from the power control module 40 and so as to control the e-bike (such as switching a status of the e-bike). The execution module 50 may include a speed variator 51 and a light device 52. The speed variator 51 is configured to adjust a gear of the e-bike and so as to adjust a speed of the e-bike. The light device 52 is configured to control a status of the lights, such as switching on and off the lights, adjusting a color, a strength, and a flash rate of the lights.

In at least one embodiment, when the power control module 40 receives a power control signal, the power control module 40 adjusts auxiliary power according to the power control signal. When the power control module 40 receives a speed control signal, the power control module 40 transmits the speed control signal to the speed variator 51, the speed variator 51 adjusts the gear of the e-bike according to the received speed control signal. When the power control module 40 receives a lighting control signal, the power control module 40 transmits the lighting control signal to the light device 52, the light device 52 switches the lights of the e-bike accordingly.

In at least one embodiment, the touch control technology of the wireless control system 1 may include, but is not limited to, resistive, capacitive, electromagnetic, and optical, etc. The wireless transmitting technology of the wireless control system 1 may include, but be not limited to, BLUETOOTH, BLUETOOTH Low Energy (BLE), ANT+, ZIGBEE, Ultra Wide Band (UWB), and Near Field Communication (NFC), etc.

The wireless control system of e-bike combines touch control technology, wireless communication, and bicycle control system, the control module 10 arranged on the handlebar of the e-bike may control functions of the e-bike, and the display 20 may display information and status of the e-bike, riding information, and information to the rider, which provides convenience for the rider and concise appearance. In addition, the first controller 11 and the second controller 12 may detect touch gestures of the rider, thus, the rider may thereby switch easily to different functions of the e-bike when riding, and this improves a riding safety and makes it easier to control the e-bike.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A wireless control system of e-bike comprising:
a control module configured to detect operation signals from a rider of the e-bike;
a display configured to transmit the operation signals and display information of the e-bike and the rider, and the operation signals;
a power control module configured to receive the operation signals and adjust an auxiliary power according to the operation signals; and
an execution module configured to adjust a speed of the e-bike and a status of lights of the e-bike.

2. The wireless control system according to claim 1, wherein the control module comprises a first controller and a second controller being wireless touch controllers, each of the first controller and the second controller comprises a touch interface configured to detect touch gestures from the rider to generate the operation signals.

3. The wireless control system according to claim 2, wherein the operation signals comprise power control signals, speed control signals, and lighting control signals.

4. The wireless control system according to claim 2, wherein the display is a wireless display that be capable of transmitting and receiving wireless signals, the display is also capable of transmitting and receiving signals by cable connection, the display is configured to receive the operation signals from the first controller and the second controller and further transmit the operation signals, the display displays a plurality of pages for showing information, the display is configured to switch the pages through the touch gesture detected by the first controller.

5. The wireless control system according to claim 1, wherein the execution module comprises a speed variator and a light device, the speed variator is configured to adjust a gear of the e-bike and so as to adjust the speed of the e-bike; the light device is configured to control the status of the lights.

6. The wireless control system according to claim 5, wherein when the power control module receives a power control signal, the power control module adjusts the auxiliary power according to the power control signal by driving it's structure;
when the power control module receives a speed control signal, the power control module transmits the speed control signal to the speed variator, the speed variator adjusts the gear of the e-bike according to the speed control signal; and
when the power control module receives a lighting control signal, the power control module transmits the lighting control signal to the light device, the light device switches the status of the lights of the e-bike according to the lighting control signal.

7. The wireless control system according to claim 1, further comprising a signal transmitting module, wherein the signal transmitting module is configured to receive the operation signals from the display and transmits the operation signals to the power control module; the power control module is connected to the display and the signal transmitting module by cables, the power control module is configured to provide power for the display and the signal transmitting module.

8. The wireless control system according to claim 2, wherein the first controller and the second controller are capable of customizing touch gestures for different functions of the e-bike.

9. An e-bike comprising a wireless control system, the wireless control system comprising:
a control module configured to detect operation signals from a rider of the e-bike;
a display configured to transmit the operation signals and display information of the e-bike and the rider, and the operation signals;
a power control module configured to receive the operation signals and adjust an auxiliary power according to the operation signals; and
an execution module configured to adjust a speed of the e-bike and a status of lights of the e-bike.

10. The e-bike according to claim 9, wherein the control module comprises a first controller and a second controller being wireless touch controllers, each of the first controller and the second controller comprises a touch interface configured to detect touch gestures from the rider to generate the operation signals.

11. The e-bike according to claim 10, wherein the operation signals comprise power control signals, speed control signals, and lighting control signals.

12. The e-bike according to claim 10, wherein the display is a wireless display that be capable of transmitting and receiving wireless signals, the display is also capable of transmitting and receiving signals by cable connection, the display is configured to receive the operation signals from the first controller and the second controller and further transmit the operation signals, the display displays a plurality of pages for showing information, the display is configured to switch the pages through the touch gesture detected by the first controller.

13. The e-bike according to claim 9, wherein the execution module comprises a speed variator and a light device, the speed variator is configured to adjust a gear of the e-bike and so as to adjust the speed of the e-bike; the light device is configured to control the status of the lights.

14. The e-bike according to claim 13, wherein when the power control module receives a power control signal, the power control module adjusts the auxiliary power according to the power control signal by driving it's structure;
when the power control module receives a speed control signal, the power control module transmits the speed control signal to the speed variator, the speed variator adjusts the gear of the e-bike according to the speed control signal; and
when the power control module receives a lighting control signal, the power control module transmits the lighting control signal to the light device, the light device switches the status of the lights of the e-bike according to the lighting control signal.

15. The e-bike according to claim 9, wherein the wireless control system further comprises a signal transmitting module, the signal transmitting module is configured to receive the operation signals from the display and transmits the operation signals to the power control module; the power control module is connected to the display and the signal transmitting module by cables, the power control module is configured to provide power for the display and the signal transmitting module.

16. The e-bike according to claim 10, wherein the first controller and the second controller are capable of customizing touch gestures for different functions of the e-bike.

17. The e-bike according to claim 10, further comprising two handlebars arranged on two sides of the rider, wherein the first controller and the second controller are arranged on the two handlebars, the display is arranged between the two handlebars.
